(19) United States
(12) Patent Application Publication
(10) Pub. No.: US 2026/0063847 A1
(43) Pub. Date: Mar. 5, 2026

(54) FABRY-PEROT CAVITY FABRICATION USING SHADOW MASKING

(71) Applicant: Government of the United States as represented by the Secretary of the Air Force, Wright-Patterson AFB, OH (US)

(72) Inventors: Hengky Chandrahalim, Beavercreek, OH (US); Samuel Campbell, Wright-Patterson AFB, OH (US)

(21) Appl. No.: 19/232,051

(22) Filed: Jun. 9, 2025

Related U.S. Application Data
(60) Provisional application No. 63/690,042, filed on Sep. 3, 2024.

(51) Int. Cl. G02B 6/293; G02B 6/02

(52) U.S. Cl. CPC G02B 6/29359; G02B 6/02052

(57) ABSTRACT

A process for creating a Fabry-Perot Cavity (FPC) sensor using Two-Photon Polymerization (2PP) includes: fabricating a mask directly on a cleaved tip of a fiber optic cable. The mask includes: a beveled central hole aligned over the core of the fiber optic cable, side extensions that extend radially beyond a cladding of the fiber optic cable. The process includes sputtering a first reflective coating over the mask and tip of the fiber optic cable, mechanically removing the mask using the side extensions, and fabricating a resonator cavity structure (RCS) using a 2PP process over the gold disc.

Pursuant to 37 C.F.R. § 1.78 (a)(4), this application claims the benefit of and priority to prior filed co-pending Provisional Application Ser. No. 63/690,042, filed Sep. 3, 2024, which is expressly incorporated herein by reference in its entirety.

### RIGHTS OF THE GOVERNMENT

The invention described herein may be manufactured and used by or for the Government of the United States for all governmental purposes without the payment of any royalty.

### FIELD OF THE INVENTION

The present invention relates generally to Fabry-Perot cavity fabrication and, more particularly, to Fabry-Perot cavity fabrication using shadow masking and two-photon polymerization.

### BACKGROUND OF THE INVENTION

As computers continue to improve and model the real world more and more accurately, it is important to measure the world as accurately as possible. For each situation, the best measurement will depend on many factors, but often, it comes down to having the most accurate data possible, and having as many accurate measurements as can be processed. Accurate and repeated measurements of physical phenomenon are crucial to intelligent decision making and automation.

Sensors are like the eyes and ears of computers in the physical world, but modern sensors can sense phenomena far beyond human senses. However, when designing a system, it is important to consider the size, weight, and power (SWAP) requirements of every single component. Minimizing size, weight, and power while keeping the same or higher degree of sensitivity enables extra design flexibility in highly optimized devices, such as satellites. Minimizing the requirements of a sensor could enable more low SWAP sensors in a system, which would provide a more complete picture to the system. Alternatively, low SWAP sensors could mean adding more mission critical capabilities.

This paper explores micro-optical Fabry-Perot Cavity (FPC) sensors fabricated with multi-step 2-photon polymerization (2PP) techniques. The process enables quality factors an order of magnitude greater than other 2PP sensors and enables exploration of other sensor geometries.

### SUMMARY OF THE INVENTION

The present invention overcomes the foregoing problems and other shortcomings, drawbacks, and challenges of sensor fabrication. While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention a process for creating a Fabry-Perot Cavity (FPC) sensor using Two-Photon Polymerization (2PP) includes: fabricating a mask directly on a cleaved and flat tip of a fiber optic cable, wherein the mask includes: a beveled central hole aligned directly over the core of the fiber optic cable; and side extensions that extend radially beyond a cladding of the fiber optic cable with respect to a central axis of the mask; sputtering a first reflective coating over the mask and tip of the fiber optic cable such that the first reflective coating adheres to the mask where the mask covers the tip and adheres to the core of the fiber optic cable where the tip is exposed; mechanically removing the mask using the side extensions such that the first reflective coating adhered to the fiber optic cable remains as a precisely centered gold disc on the tip; fabricating a resonator cavity structure (RCS) using a 2PP process over the gold disc, wherein the RCS includes a RCS tip; sputtering a second reflective coating over the RCS tip, wherein the second reflective coating adheres to an external surface of the RCS tip. The first reflective coating and the second reflective coating are aligned in parallel such that the resonator cavity structure acts as an FPC when light passes along the fiber optic cable and through the first reflective coating.

According to another embodiment of the present invention, a process for creating a Fabry-Perot Cavity (FPC) sensor using Two-Photon Polymerization (2PP) includes: fabricating a mask directly on a cleaved and flat tip of a fiber optic cable, wherein the mask includes: a beveled central hole aligned directly over the core of the fiber optic cable; and side extensions that extend radially beyond a cladding of the fiber optic cable with respect to a central axis of the mask; sputtering a first reflective coating over the mask and tip of the fiber optic cable such that the first reflective coating adheres to the mask where the mask covers the tip and adheres to the core of the fiber optic cable where the tip is exposed; mechanically removing the mask using the side extensions such that the first reflective coating adhered to the fiber optic cable remains as a precisely centered gold disc on the tip; fabricating a resonator cavity structure (RCS), wherein the RCS includes a RCS tip; sputtering a second reflective coating over the RCS tip, wherein the second reflective coating adheres to an external surface of the RCS tip. The first reflective coating and the second reflective coating are aligned such that the resonator cavity structure acts as an FPC when light passes along the fiber optic cable and through the first reflective coating.

According to yet another embodiment of the present invention, a Fabry-Perot Cavity (FPC) sensor includes a first reflective surface comprising a reflective disc deposited through a removable mask, the mask having been fabricated directly on a tip of a fiber optic cable, a resonator cavity structure (RCS) fabricated using a 2PP process over the reflective disc, wherein the RCS includes an RCS tip; a second reflective surface deposited on the RCS tip, such that the first reflective surface and the second reflective surface are in optical communication to create an FPC when light passes along the fiber optic cable and through the first reflective coating. The mask, while on the fiber optic cable, includes: a beveled central hole aligned directly over the core of the fiber optic cable; and side extensions that extend radially beyond a cladding of the fiber optic cable with respect to a central axis of the mask.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 shows a simplified model of operational principles of a Fabry-Perot Cavity (FPC).

FIG. 2 shows a graphical depiction of the resonant longitudinal modes of a cavity, examples of transmitted spectra for various reflectances, and corresponding reflected spectra.

FIG. 3 shows a fiber optic cable with the jacket partially stripped and main components of a single mode fiber optic cable.

FIG. 4 shows a process for generating a partially coated wafer using a shadow mask.

FIG. 5 shows an exemplary process for partially coating a fiber optic cable using a shadow mask.

FIG. 6 shows an exemplary mask for partially coating a fiber optic cable.

FIG. 7 shows a fiber optic cable including an exemplary mask and a first reflective coating, according to one or more embodiments shown and described herein.

FIG. 8 shows a fiber optic cable and a resonator cavity structure.

FIG. 9 shows a fiber optic cable with the resonator cavity structure and a second reflective coating.

FIG. 10 shows an exemplary fiber optic cable and masking device.

FIG. 11 shows a scanning electron microscope image of a fiber optic cable, resonator cavity structure, and second reflective coating on a tip of the fiber optic cable.

FIG. 12 shows testing apparatus for testing an FPC at the end of a fiber optic cable.

FIG. 13 shows an FPC device and a spectra comparison for the FPC device derived using the testing apparatus of FIG. 12.

FIG. 14 shows exemplary aspects of embodiments of FPC devices according to one or more embodiments shown and described herein.

FIG. 15 shows a reflected spectra for a same device with and without a top gold reflective layer.

FIG. 16 shows a reflected spectra for a same device with two reflective coatings, and a reflective coating only on the top.

FIG. 17 shows a reflected spectra for the same device with different thicknesses of gold coatings on the bottom of the FPC.

FIG. 18 shows direct measurements of a base spectrum and a return spectrum of a device and a normalized response for the same device, according to one or more embodiments shown and described herein.

FIG. 19 shows an example of Lorentzian fit for a peak with a spectrum inverted to match the more conventional shape of a Lorentzian function.

FIG. 20 shows an average wavelength attenuation from input to output for one or more embodiments shown and described herein.

FIG. 21 shows resonance peaks for a device according to one or more embodiments shown and described herein with a 20-micron diameter core.

FIG. 22 shows aspects of an FPC device, according to one or more embodiments shown and described herein.

FIG. 23 shows a temperature shift for devices before deformation in water.

FIG. 24 shows aspects of an FPC device, according to one or more embodiments shown and described herein.

FIG. 25 shows a spectrum measured with a 15-micron diameter device, with a reference air temperature of 120° C.

FIG. 26 shows a linear fit taken with points determined to be a part of an original device performance.

FIG. 27 shows aspects of two spectra measured at 20° C. with a 20-micron diameter device.

FIG. 28 shows a visible spectrum shift for different concentrations of salt.

FIG. 29 shows a spectrum shift for peak 5 with respect to chemical concentration for ordinary table salt.

FIG. 30 shows a visible spectrum shift for different concentrations of acetic acid in water.

FIG. 31 shows a spectrum shift for peak 5 with respect to chemical concentration for acetic acid in water.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

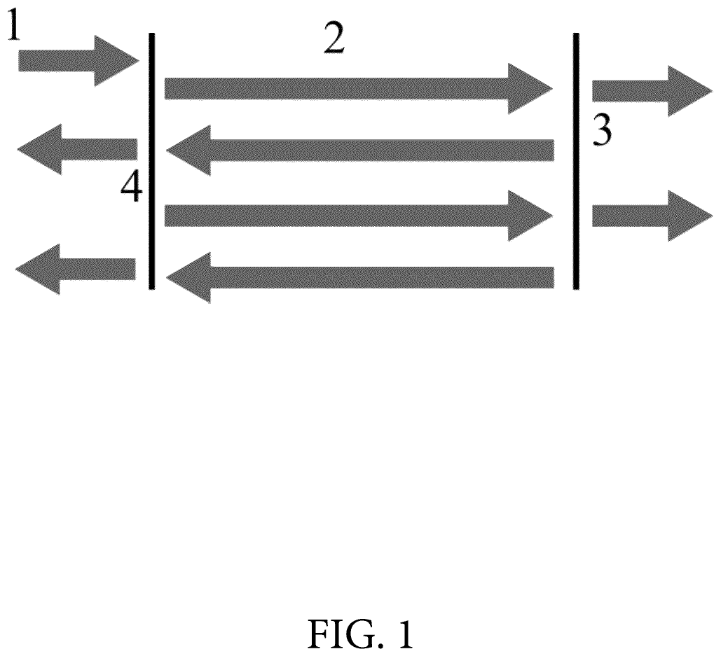

The Fabry-Perot Cavity (FPC) is a type of passive optical device that uses two mirrors to create interference fringes. This type of structure can be fabricated on the tip of a fiber optic cable to provide a highly responsive sensor with low size, weight, and power requirements. FPCs consist of two mirrors reflecting light back and forth between each other in a cavity. The mirrors are typically partially transmissive, so as to allow some light to enter and leave. A simplified model is shown in FIG. 1. At 1), a light ray (grey arrow) is entering the cavity through the mirror (black line) on the left. At 2), the light ray travels the distance of the cavity. At 3), the light partially transmits and partially reflects at the mirror on the right. The light then travels back across the cavity and at 4), the light partially transmits and reflects and repeats from step 2.

Since light has a wave nature, it will display constructive and destructive interference with itself depending on the length of the cavity relative to the wavelength. The change in the phase of the light after some integer n round trips in a cavity can be expressed as:

$${δ}_{n} = \frac{4 π}{{λ}_{0}} nL , \qquad ( 1 )$$

where λ₀ is the wavelength of the light in the cavity, and L is the length of the cavity. To determine the effect of the interference, the magnitude of the light must also be known. For this derivation, only the transmitted spectrum will be calculated, but the reflected spectrum can just be taken as the base spectrum minus the transmitted spectrum in the lossless case. The relative magnitude m of a wave after n round trips inside the cavity can be expressed as:

$${m}_{n} = {t}_{1} {t}_{2} {r}_{1}^{n - 1} {r}_{2}^{n} . \qquad ( 2 )$$

where t₁ is the coefficient of transmission at the first mirror, t₂ is the coefficient of transmission at the second mirror, r₁ is the coefficient of reflection at the first mirror, and r₂ is the coefficient of reflection at the second mirror. To add the waves together, we must add their fields. Assuming an initial amplitude of E₀, the n^{th} field can be expressed as:

$${E}_{n} = {E}_{0} {m}_{n} {e}^{j ( ω t - {δ}_{n} )} \qquad ( 3 )$$

Since there is a common ratio of r₁r₂^{ejδn} between each term, a geometric series can be taken, so the final result is:

$${E}_{t} = {E}_{0} \frac{{t}_{1} {t}_{2}}{1 - {r}_{1} {r}_{2} {ϵ}^{j {δ}_{n}}} . \qquad ( 4 )$$

Therefore, the actual intensity being measured would be:

$${I}_{t} = \frac{{I}_{0}}{1 + F {sin}^{2} \frac{δ}{2}} , \qquad ( 5 )$$

where F is the finesse, and can be expressed as:

$$F = \frac{π \sqrt{R}}{{( 1 - R )}^{2}} , \qquad ( 6 )$$

and R=r₁r₂.

From the interference pattern in Iₜ, the resonance peaks can be found when double the cavity length is an integer multiple of the wavelength. This also makes sense intuitively because when a light wave has an integer number of wavelengths in a round trip, it will be in the same phase as itself and constructively interfere. In equation form the resonance peaks can be determined by

$${λ}_{m} = \frac{2 nL}{m} . \qquad ( 7 )$$

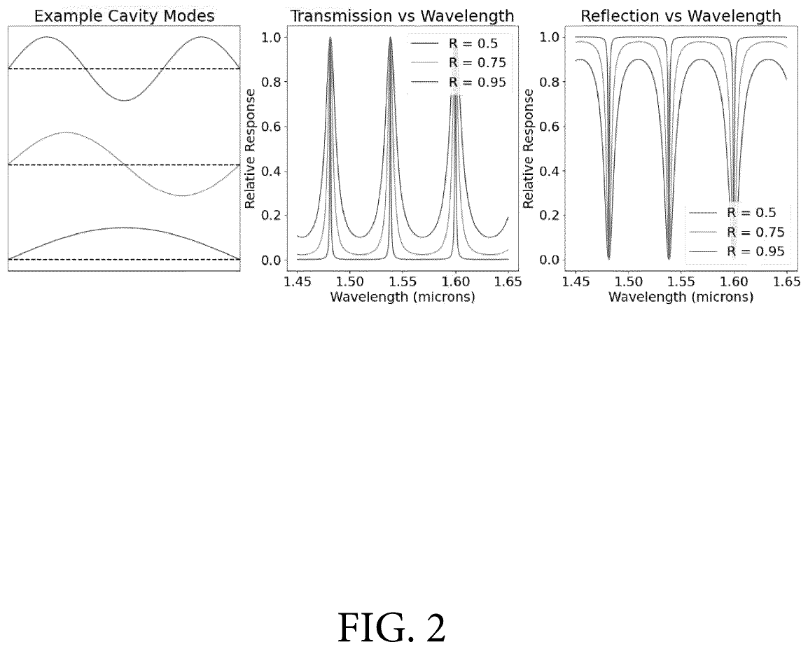

Here, n is the refractive index, which would increase the optical path length. Lis still the length of the cavity, and m is the longitudinal mode order. Various examples are shown in FIG. 2, which is a graphical depiction of the resonant longitudinal modes of a given cavity. Modes must be sinusoid going to zero at boundaries. The graph at the center of the figure shows examples of the transmitted spectra for various reflectances. On the right, FIG. 2 shows the corresponding reflected spectra.

A useful metric is the free spectral range (FSR) of a cavity. The free spectral range is the space between adjacent resonant peaks. The equation is:

$$Δ {v}_{FSR} = \frac{{c}_{0}}{2 nL} . \qquad ( 8 )$$

FIG. 2 does not include alternative cavity lengths. Changing the cavity length would change the location of the resonance peaks but would not drastically alter the shape. Instead, different reflectances are displayed, since different reflectances have significant effects on the shape of each resonance peak. As the reflectance increases, the peaks become notably narrower but still peak in the same location. The measure used for width of peaks is the full width half max (FWHM), which is defined as the full width of the peak where it is half of its maximum value. This can be expressed as:

$${Δλ}_{FWHM} = \frac{{Δλ}_{FSR}}{} \qquad ( 9 )$$

Here, [symbol] is the coefficient of finesse, which can be expressed as:

$$= \frac{π \sqrt{F}}{2} . \qquad ( 10 )$$

And as shown in Equation 6, as reflectance increases, so does finesse, which means coefficient of finesse increases, which from Equation 9, means the peaks will be narrower. And indeed, this is the trend seen in FIG. 2.

To quickly summarize the key aspects of a FPC, quality factor (Q) is often used. Q is a description of how much energy can be stored in the modes of a cavity. The equation for this is:

$$Q = \frac{{v}_{0}}{δ v} . \qquad ( 11 )$$

Q increases as the finesse increases, which means narrower peaks yield a higher quality factor. The FPC came about in the late 1800s when French Physicists Charles Fabry and Alfred Perot were trying to distinguish spectral lines when viewing stars. Their proposed interferometer consisted of two parallel thin silver films, and it later adopted their name. From FIG. 2, different wavelengths would have different amounts of round trips inside the cavity. The condition for distinguishability is often referred to as a FWHM. If the separation between two wavelengths of interest is a FWHM, their peaks should be distinguishable.

Due to the confinement of light to a small volume, FPCs are also ubiquitous in the field of lasers. A gain medium is a medium which has electrons in an excited state ready to emit at a specific wavelength. Due to the confining nature of FPCs, radiation of a specific wavelength will fill the cavity and cause stimulated emission of photons in the gain medium. For the first ever laser, a 1 cm long ruby crystal was used as the gain medium, and the electrons were excited using a broadband light source. The crystal had a silver coating on either side, making the reflective necessary for an FPC.

Light refracts at a dielectric boundary between different media in accordance with Snell's Law, shown below:

$${n}_{1} sin {θ}_{1} = {n}_{2} sin {θ}_{2} . \qquad ( 12 )$$

Here, n₁ is the refractive index of the initial medium, θ₁ is the angle relative to the surface normal at which the light is incident upon the boundary, n₂ is the refractive index of the gaining medium, and θ₂ is the angle of refraction relative to the surface normal into the new medium. If the initial medium has a higher refractive index than the gaining medium, there will be a critical angle where light refracting into the new medium is refracted perpendicular to the surface normal. This critical angle is:

$${θ}_{c} = arcsin ( \frac{{n}_{2}}{{n}_{1}} sin {θ}_{1} ) . \qquad ( 13 )$$

For incident angles greater than the critical angle, all light reflects off the boundary. This is called total internal reflection. Light has been guided along a specified path using total internal reflections since the mid-1800s using water or glass as the high index medium. In the mid-20th century, theoretical work in optics eventually yielded fiber optic cables. There are many different kinds of fiber optic cables. The main types are single mode and multi-mode fibers, and within multi-mode fibers, there are step index and graded index. Modes are the solutions for an electromagnetic wave from Maxwell's Equations in cylindrical coordinates.

Single mode fibers have the highest bandwidth and lowest attenuation of the various kinds of optical fibers, with some single mode fibers attenuating as little as 0.2 dB/km, as opposed to 1-6 dB/km for multi-mode fibers. Additionally, fiber optic cables are virtually immune to outside attacks. Fiber optic cables do not emit any measurable signal, and discreetly cutting a fiber optic cable without alerting both the transmitter and receiver is virtually impossible. Finally, fiber optic cables have very low size, weight, and power requirements, so for all these reasons, single mode fibers are the backbone of modern telecommunications.

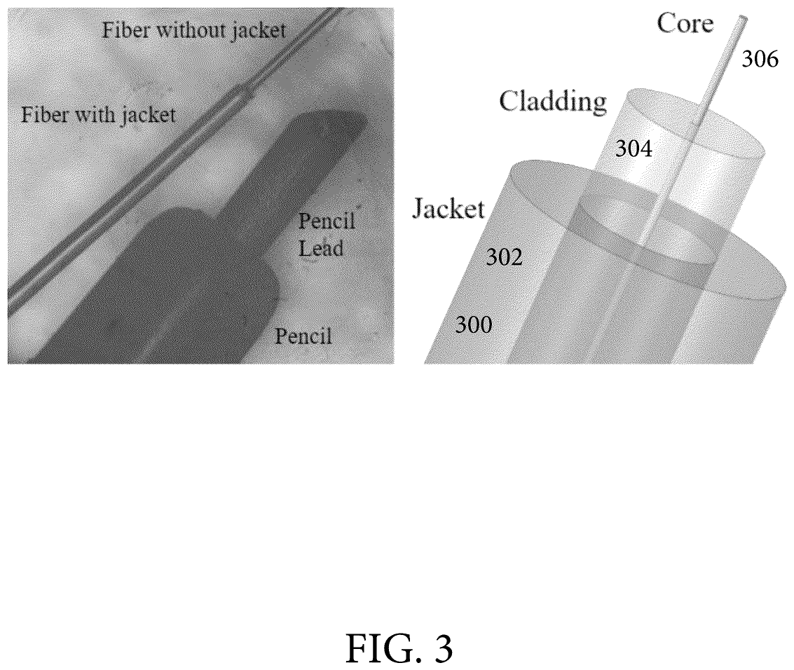

Only the core and cladding of the single mode fiber is discussed herein, though the principles described herein are applicable to other types of fibers. Referring to FIG. 3, an exemplary fiber optic cable 300 is shown. The fiber optic cable 300 includes a jacket 302, a cladding 304, and a core 306. The core 306 is the small region in the middle of the fiber where the light is contained, and the cladding 304 is the large glass buffer around the core 306 onto which devices will be fabricated. Other protective layers (e.g., the jacket 302) are removed for the custom fabrication process. The left side of FIG. 3 shows a 0.7 mm pencil lead and pencil for a standard mechanical pencil for scale.

One parameter of concern for this paper is the numerical aperture (NA). NA is a description of the maximum angle at which light can be accepted or transmitted from the fiber. Light comes out in a roughly conical shape, with the shape determined by the NA and refractive index of the new medium. The equation for NA for a fiber optic cable is:

$$NA = \sqrt{{n}_{1}^{2} - {n}_{2}^{2}} . \qquad ( 14 )$$

Here, n₁ is the refractive index of the core, and n₂ is the refractive index of the cladding. The angle of the cone of interest depends on the refractive index of the medium at the end of the fiber. Acceptance angle for any NA is:

$$α = arcsin \frac{NA}{n} . \qquad ( 15 )$$

Here, n is the refractive index the light is traveling into, and a is the acceptance angle relative to the optical axis. Some embodiments described herein may utilize a step index fiber with an effective group RI of 1.4679 at 1550 nm, which may display a NA of 0.14 and an attenuation of 0.20 dB/km at 1500 nm. In some embodiments, the core diameter can be 8.2 microns, and the cladding diameter is 125 microns, but embodiments are not limited to these particular dimensions.

All previous work on fiber optic FPCs have either made a completely static monolithically integrated structure or a movable multi-piece structure. The primary ad-vantage of the former is that there is minimal optical misalignment, and there is no mechanical manipulation involved. However, it is functionally impossible to deposit precise reflective coatings on both ends of the FPC. Depositing coatings before printing is also not viable because when the Nanoscribe tries printing on a reflective surface, the pulse strongly reflects and boils the resin in contact with the surface. On the other hand, movable structures can deposit high-quality reflective coatings in different places, meaning each reflective layer of the FPC can be highly controlled and reflective. However, micro-manipulation can cause fractures or optical misalignments easily.

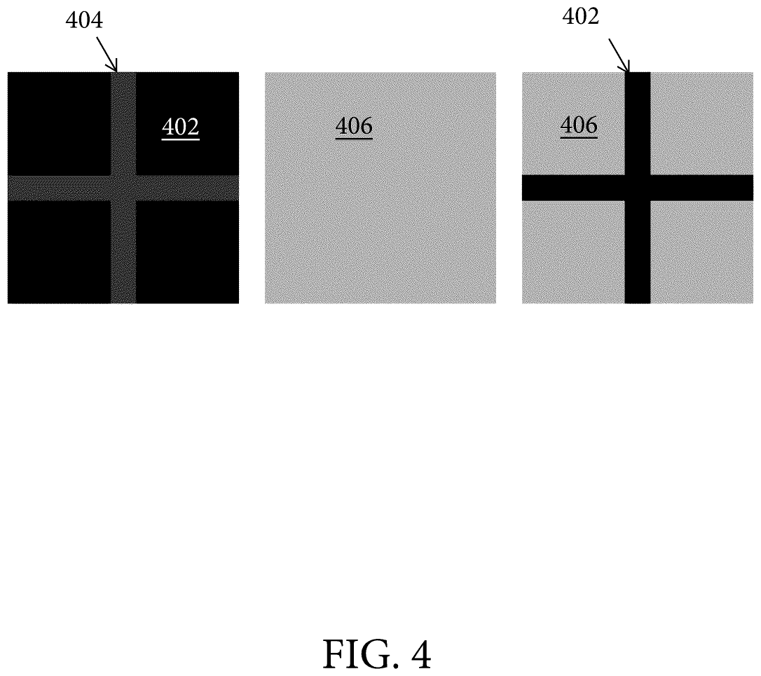

In microelectronics, the primary way of fabricating wafer designs is by putting down masks, treating the entire wafer, and then removing the mask. The mask is some thin layer of a material that can be hardened in specific spots, thus preventing the treatment from affecting the entire wafer. An example is shown in FIG. 4. From left to right, the wafer 402 has a mask 404. Then, a coating 406 is applied to top surfaces of both the wafer 402 and the mask 404. Finally, the mask 404 is removed from the wafer 402, which has been coated in the coating 406. Removing the mask 404 exposes the portions of the wafer 402 that were not coated by the coating 406 due to the presence of the mask 404. If the particular coating selected is a reflective coating (e.g., gold, etc.) and the wafer is not reflective, the portions of the wafer that have been coated with the reflective coating will be reflective. If the wafer is not reflective, the uncoated portions of the wafer will not be reflective.

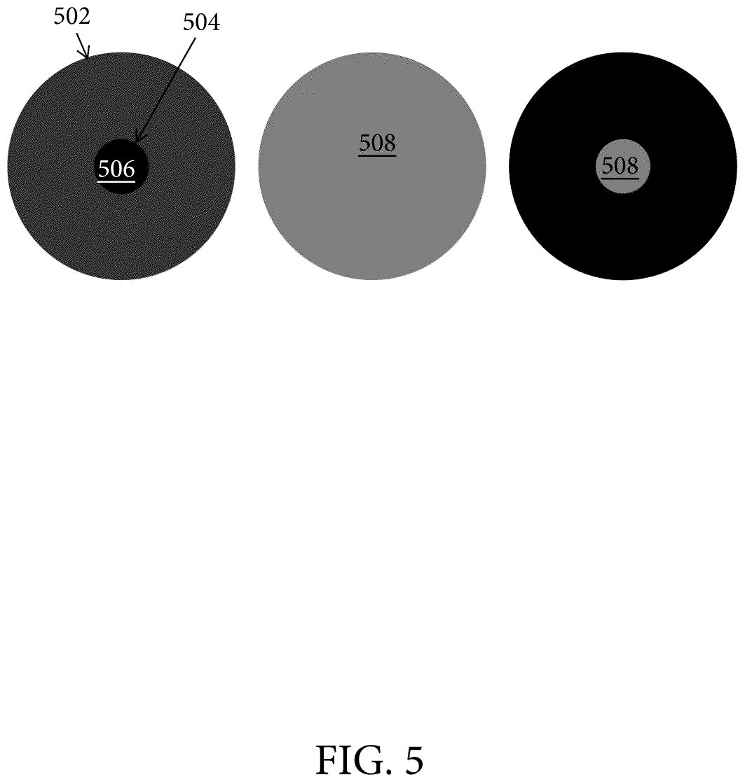

For fiber optic devices (e.g., fiber optic cables, etc.), this can be particularly relevant because a high-quality reflective layer may be desired on some portions of the device but not others. However, heretofore, there has been no way to discriminately deposit such reflective layer onto a surface of a fiber optic device. That is, taking the example of a fiber optic cable with cladding and core, all available deposition methods would deposit over both cladding and core (i.e., an entire end surface of a fiber optic cable). If a mask technique were used, a reflective coating could be deposited in a small area of the fiber tip, and then a resonator could be structurally adhered around the gold coating. An exemplary process, viewed from top down, is shown in FIG. 5. As shown, and similarly to FIG. 4, a mask 502 is deposited on a surface of an object masking the entire surface except for a core 504, such that an upper surface 506 of the core 504 is exposed. Subsequently, a reflective coating 508 is deposited (e.g., using sputtering or other process) over both the mask 502 and the core 504. Subsequently, the mask 502 is removed, leaving the reflective coating 508 only over the core 504.

Complicating the difficulty of manufacturing articles according to the processes described herein, traditional wafer-style photo-lithography methods do not generally work on fiber optic cables. Accordingly, other methods and/or tools, such as, for instance, the Nanoscribe PPGT may be used. These methods may be used to align fibers within an accuracy of 1 micron, and a 2D mask can be printed on the end of a fiber optic cable, along with mechanical parts to lift off the mask after printing. In embodiments described herein, the mask can be an organic polymer, while the reflective coating may be an inert metal, such as, for instance, gold. For typical wafer lithography, an organic solvent can be used, which may remove all traces of organic polymer, while not being able to react with the inorganic metal coating. However, in some embodiments considered herein, masks may be removed with, for example, a micro-manipulator (e.g., a small needle). In such embodiments, as will be explained in greater detail below, one or more features of the mask (e.g., a bevel) may enable a circular disc to form on the core while the masking feature does not contact the circular disc, enabling the mask to completely detach from the fiber optic cable without ever contacting a metal disc that may be deposited through the mask over the core. Hence, as the mask lifts off, there is minimal chance for the metal on the fiber to peel off with the mask, as explained in greater detail herein.

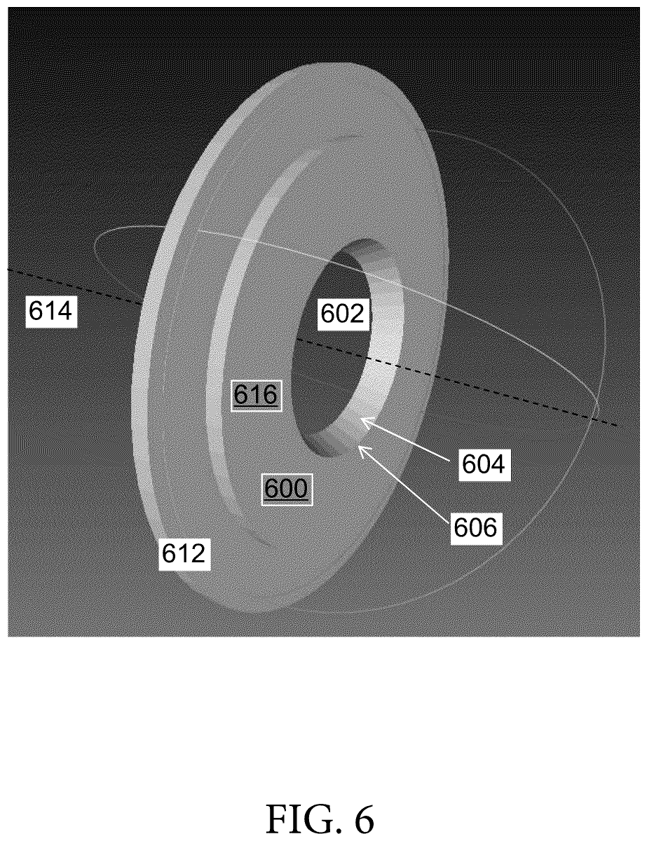

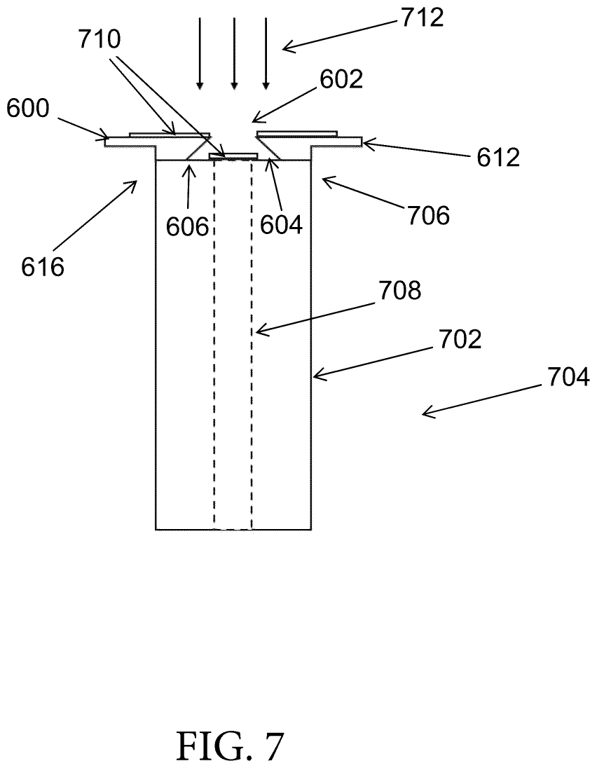

FIG. 6 shows an embodiment of a mask 600 for masking and manufacturing onto a fiber optic cable a tip of a fiber optic cable (not shown in FIG. 6). Viewing FIG. 6 with the perspective shown in FIG. 7, a bottom face 616 of the mask 600 contacts and faces the cladding 702 surrounding a core 708 of a fiber optic cable 704. The mask 600 may be in place at a tip 706 of the fiber optic cable 704 during deposition of a reflective coating 710. The reflective coating 710 is deposited in a deposition direction as shown by arrows 712. The general alignment between the hole 602 in the mask 600 and the core 708 of the fiber optic cable 704 means that the reflective coating 710 is selectively deposited over the core 708. When the mask 600 is removed, the tip 706 of the fiber optic cable 704 has reflective coating 710 over the core 704 and other structures of the FPC can be built over the reflective coating 710 as discussed herein.

Referring again to FIG. 6, because the methods used to create this mask 600 are capable of operating in all three dimensions and, thus, of making 3D structures, a hole 602 along a central axis 614 of the mask 600 can include a bevel 604. That is, the hole 602 may be a beveled, central hole that can, in some embodiments, align directly over a core of a fiber optic cable as shown in FIG. 7. The hole 602 can have any geometry and may generally correspond to a geometry of the core 708. For instance, the hole 602 may be slightly larger in radius than the core 708 such that the first reflective coating covers an entirety of the end of the core 708. In embodiments with multiple cores, the mask 600 may include multiple holes corresponding with one or more of the multiple cores. In some embodiments including multi-core fibers, not all of the fiber cores may include a reflective coating and/or FPC at an end of the core(s).

The bevel 604 may minimize undesired effects around a bottom corner 606, with respect to the reflective material along the inner wall of the hole 602 in the mask 600, such as, for example, pooling or sticking. In embodiments, a maximum outer radius of the mask 600 may measure sufficiently such that side extensions 612 of the mask 600 extend further outward (i.e., radially outward with respect to the central axis 614), beyond a cladding of a fiber optic cable (not shown). These side extensions 612 may enable mechanical removal of the mask 600 from the tip of the fiber optic cable once the reflective coating has been deposited, as explained in greater detail herein.

As briefly discussed above, for device fabrication, the mask shown in FIG. 6 can be printed onto an end surface of a fiber optic cable. Then, the tip of the fiber optic cable can be loaded into a sputtering machine with the tip of the cable and the mask 600 facing a source of film sputter. A film (e.g., a high-quality gold film or other reflective coating such as, for example, silver, platinum, aluminum, etc.) can be deposited onto the entire fiber. This film can be a first reflective coating coated over the mask and tip of the fiber optic cable. Because of the mask, the first reflective coating can be a precisely centered reflective (e.g., gold, silver, platinum, aluminum, etc.) disc on the tip of the core of the fiber optic cable, as explained in greater detail herein. The thickness of the film can vary depending on the properties of the material deposited as the reflective coating. For example, if gold is used as the first reflective coating, a thickness of the film can be between 10 and 25 nm, for example, 20 nm. The thickness of the film may be determined, based on, for example, an ideal gold thickness according to a python plasmonics simulation for a given wavelength. Above a certain thickness, depending on material properties, the first reflective coating may not provide sufficient transmission to act as a base of the FPC. The selection of the material used for the first and second reflective coating may depend on multiple factors including transmissivity, inertness, wavelength of interest, availability, etc. The thickness of the first and second reflective coatings will depend on the properties of the material selected for the coatings. Additionally, the first and second coatings can be different materials and different factors and properties may be used to select the coatings. An upper bound of the thickness of the coating may be based on wavelength of the signal of interest.

Next, the mask can be removed using, for example, simple micro-mechanical manipulation, leaving a small reflective (e.g., gold) disc, precisely centered on the tip of the fiber (e.g., covering the core). Since the reflective disc is in the center of the tip, a resonator cavity structure can be printed on the center of the tip of the fiber with the gold disc inside.

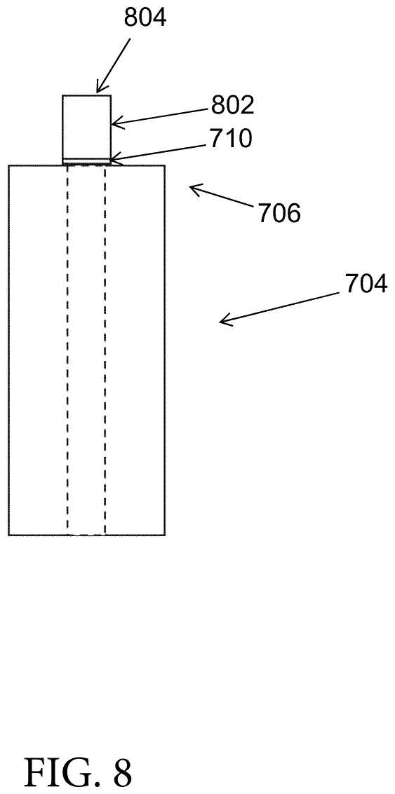

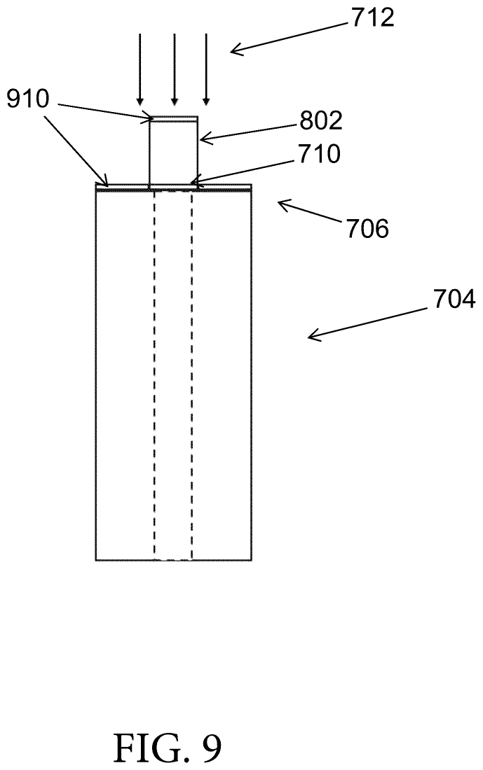

FIG. 8 shows the fiber optic cable 704 of FIG. 7 with a resonator cavity structure (RCS) 802 printed on the reflective coating 710. The RCS 802 can be printed on the reflective coating 710 at the tip 706 of the fiber optic cable 704 using a 2PP process and may have an RCS tip 804 that is a generally flat surface at the end of the RCS. FIG. 9 shows a second reflective coating 910 deposited on the RCS tip 804 (FIG. 8) at the end of the RCS 802. The second reflective coating 910 can be deposited using a similar process for depositing the first reflective coating 710 (i.e., in a deposition direction shown by arrows 712). Because in some embodiments, it may not be necessary to be as discriminate with the location of the second reflective coating 910, the second reflective coating can cover more of an external face of the fiber optic cable 704. As mentioned, the first and second reflective coatings can be an inert metal (e.g., gold, silver, aluminum, platinum, etc.) but in some embodiments, the first and second reflective coatings can be selected from various oxides and nitrides, which may vary in their properties.

Though FIG. 3, FIG. 6, FIG. 7, and FIG. 8 show optical fibers with a single core, optical fibers with multiple cores are considered herein. In such embodiments, a mask may be developed with a corresponding hole or holes over one or more of the corresponding cores. Over each of the corresponding cores, a first reflective coating(s) could be deposited via the methods described herein, and subsequently, an RCS or multiple RCSs could be constructed on top of the first reflective coating(s) followed by respective second reflective coating(s) per the processes described herein. Accordingly, in fiber optic cables with multiple cores, each of the cores could have individual FPCs. Additionally, while gold is generally discussed as the first and second reflective coating(s) herein, embodiments could utilize other materials for these coatings, which may include reflective metals and dielectric materials characterized by inertness, chemical stability, and corrosion resistance. Exemplary suitable metals, in addition to gold, may include platinum, silver, palladium, aluminum, rhodium, and iridium. Gold, platinum, and rhodium may be particularly notable due to their combination of high reflectivity, chemical stability, and inertness. Embodiments utilizing silver may also include additional coatings (e.g., protective coatings) due to susceptibility to oxidation and corrosion in certain environments. Additionally, exemplary dielectric materials suitable for inclusion may include silicon nitride (Si₃N₄), titanium dioxide (TiO₂ or titania), zirconium dioxide (ZrO₂ or zirconia), hafnium dioxide (HfO₂ or hafnia), and aluminum oxide (Al₂O₃ or alumina), each exhibiting desirable optical and chemical characteristics.

For gold specifically, a thickness of the first gold reflective layer may range between 10 nm and 25 nm. Preferably, the thickness of the first gold reflective layer may range between 13 nm and 22 nm. More preferably, the thickness of the first gold reflective layer may range between 17 nm and 20 nm. The thickness of the second gold reflective layer may be greater than 25 nm. Preferably, the thickness of the second gold reflective layer may be greater than 30 nm. More preferably, the thickness of the second gold reflective layer may be greater than 35 nm.

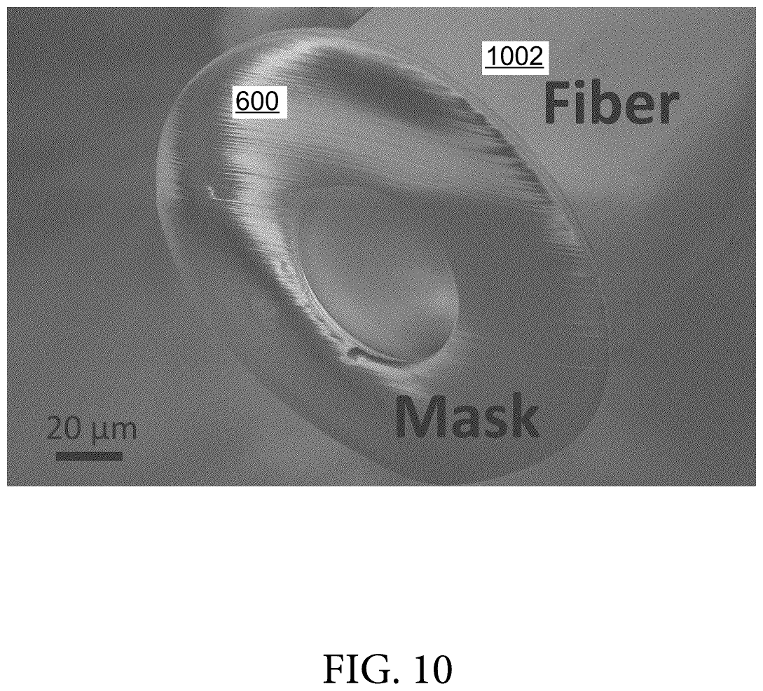

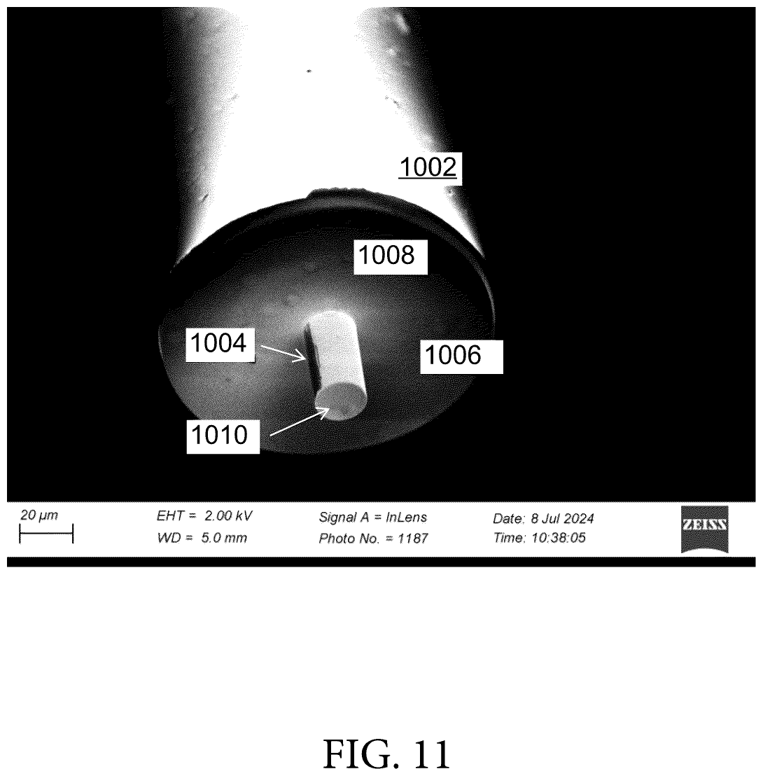

FIG. 10 shows a tip of an optical fiber 1002 with a mask 600 present on the tip of the optical fiber. FIG. 11 shows an optical fiber 1002 with an RCS 1004 printed on, and extending outward from a center of a tip 1006 of the optical fiber 1002. A second reflective coating 1008 has been sputtered onto an end face at the tip 1006 of the optical fiber 1002 such that the tip 1006 of the fiber and an RCS tip 1010 are coated with the second reflective coating 1008. This second coating (e.g., gold, silver, platinum, aluminum, or other reflective coating) can be of sufficient depth such as to have essentially zero transmittance (e.g., 100 nm). With essentially zero transmittance, return power (i.e., the power of light reflected by the second reflective coating 1008 and returning through the core of the optical fiber 1002) is maximized. The particular device shown in FIG. 11 is a 20-micron diameter cylinder with a height of 40 microns. The entire fiber and device are coated in a 100 nm layer of gold, and beneath the cylinder, there is a 40-micron diameter disc of gold that is 20 nm thick from the mask step. However, this disc is not visible in FIG. 11.

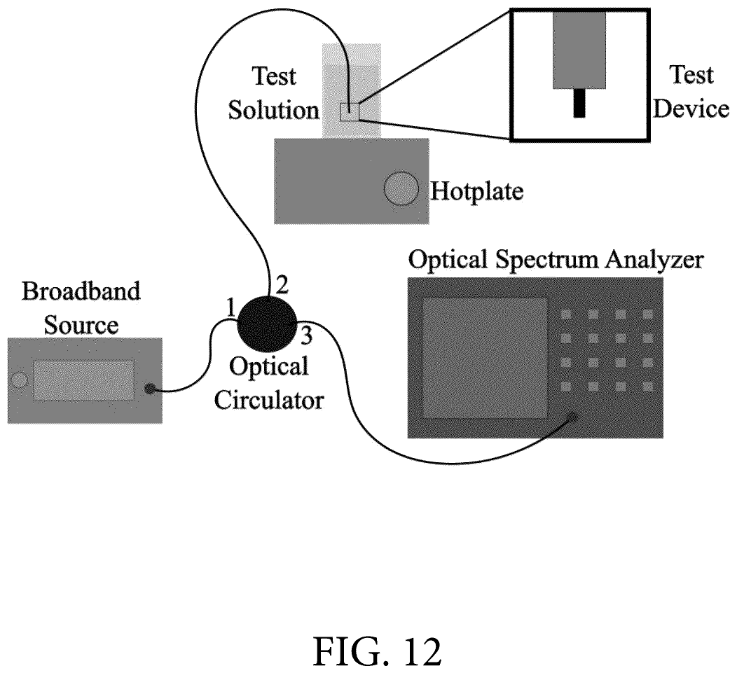

FIG. 12 shows an optical setup for testing devices such as the optical fiber and RCS of FIG. 10 and FIG. 11. Light can be injected into a fiber optic cable with a NIR broadband source from 1450-1650 nm, which can then lead to an optical circulator. The optical circulator can send the light to the device, and then the device can reflect the light to, for example, a Yokogawa 6730C OSA. Interference happens at the test device based on environmental conditions. The reflected spectrum from the device can be sent back to the circulator and then the spectrum can be sent to the OSA to be measured.

For temperature sensing tests, the device can be connected to the optical test setup and then heated along with thermal probes to provide a reference device temperature. Tests can be done with the device and probe in heated air and in heated water. For each test, to make sure the temperature reading is as accurate as possible, the setup can be left untouched for at least one minute to reach thermal equilibrium.

For heating in water, the submersible ThermoFischer TCX16 probe can be used, and for air heated tests, both the ThermoFischer TCX16 and Agilent U1182A probes can be used. To make sure the temperature remains as steady as possible throughout a measurement, devices can be submerged in water and then heated. To make sure bubbles do not form on the device, a stir rod can constantly agitate the water. For tests, a submersible temperature probe can be placed in the water, and that temperature can be recorded as the theoretical temperature of the device.

For refractive index (RI) tests, large and small changes can be measured. First, the device can be measured in regular atmospheric air, then submerged in water. To test small RI changes, different soluble compounds were mixed into water at various concentrations. Sodium chloride and acetic acid can be used. Since it can be difficult to determine the exact refractive index of each solution over the entire wavelength range of interest, chemical concentrations for each solution may be reported.

For all tests, the OSA can report the total power measured within a specific wavelength range. Instead of trying to make all the ranges line up exactly from test to test, the measured power can be converted to a spectral flux. This can be completed by dividing the total power in a bin by the bandwidth of that bin. The spectral flux is a measure of the instantaneous power at a given wavelength. Integrating over an entire spectral flux with respect to wavelength would give the total power received.

For some series of tests, the reflective layers used on the top and bottom of the FPC were varied. These tests were about the effect of gold on the resonance of each device, so tests were done in as close to the same conditions as possible, so as to isolate the effect of designs on the quality factor.

The first test were open core tests for determining the effect of optical confinement and varying gold thicknesses on the response of these micro-optical resonators. The first test done was with an open resonator, no reflective gold coatings.

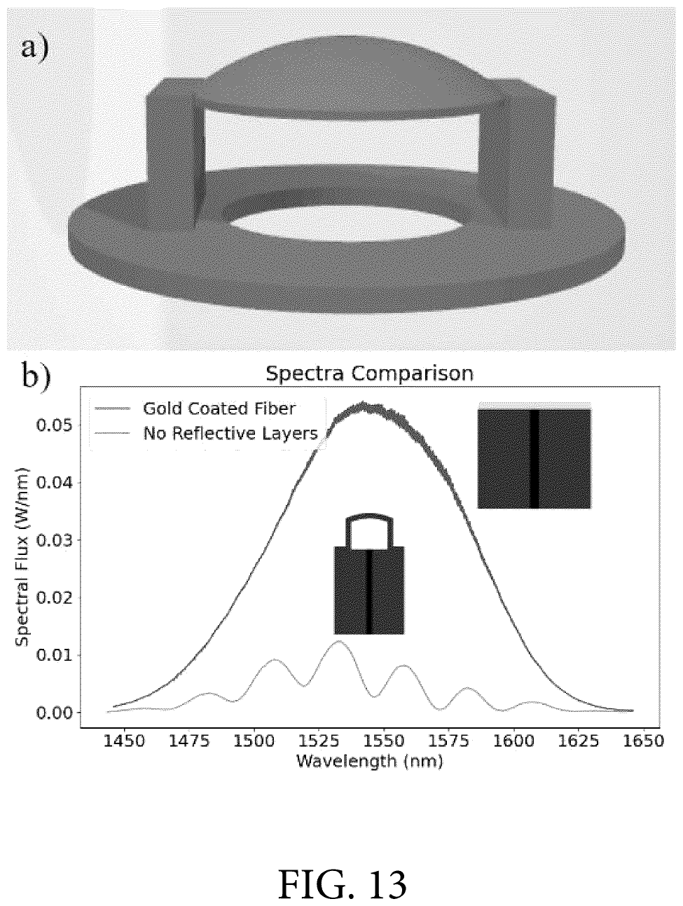

To determine the base spectrum coming from the broadband source, a 100 nm gold film with near total reflectance was deposited onto a flat fiber tip with no device. This spectrum was used to normalize all measured spectra from devices, as well as give the scale for return power from each design. FIG. 13 shows a 3D design of an embodiment featuring aspects of the device disclosed herein. In the device shown in FIG. 13, the flat part was printed onto the fiber and aligned so the concave mirror on top would reflect light back to the core of the fiber. The lower section (b) of FIG. 13 shows a base spectrum of NIR source and a return spectrum of an uncoated device. Also shown are cross-sections of each individual test to indicate what is being done. The cross-sections are not to scale.

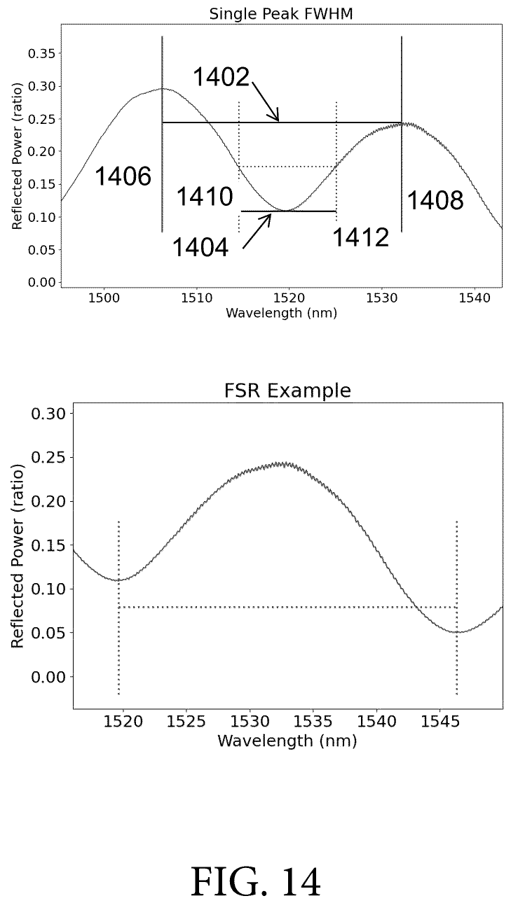

To quantify an FPC, the FWHM, FSR, and quality factor must be calculated. Before those can be calculated, the spectrum must be normalized. To do this, the device response can be divided by the baseline received from the thick gold film on a fiber tip. For all devices, this number comes out to be between 0 and 1. From there, the FWHM and FSR can be directly measured using the relative response of the cavity for low quality factors. The resonance peaks are the dips towards zero, so the high peaks can be considered to be the delineation between adjacent sets of peaks. From there, the lower of the two top peaks around a resonance peak can be taken to be the ceiling. Then, the threshold for FWHM can be set to the average of the ceiling and the bottom of the resonance peak. The FWHM can be measured as the width of the resonance at or below the threshold. An example of this is shown at the top of FIG. 14.

In FIG. 14, the black bar 1402 across the top is the width of the entire part of the spectrum considered in this resonance peak. The resonance is the dip downwards, and the high points are the delineations 1406, 1408 between resonance peaks. The top black bar is set as the zero point from which the resonance is measured. This zero point is the lower of the two high spots around the resonance. The black bar 1404 along the bottom highlights the minimum value for the resonance peak. The dashed vertical lines 1410, 1412 show where the resonance peak goes below the threshold for FWHM. The horizontal distance of the horizontal dashed line is measured as the FWHM.

For the FSR, the minimum value of each peak was taken to be the center of each peak. Therefore, the distance from peak to peak was measured as the FSR. This is shown in the bottom of FIG. 14. The vertical dashed lines highlight the resonance peaks, which are identified as the local minima between local maxima. The horizontal line is the measurement taken to be the FSR. Since FSR is periodic in frequency domain, the FWHM and FSR were converted to their respective frequency values as well. These values were then used to calculate the quality factor of the FPC. As an example for the first resonator, the FWHM was measured as 1.97 THz, the FSR was measured as 3.40 THz, and the quality factor was calculated as 1.004.

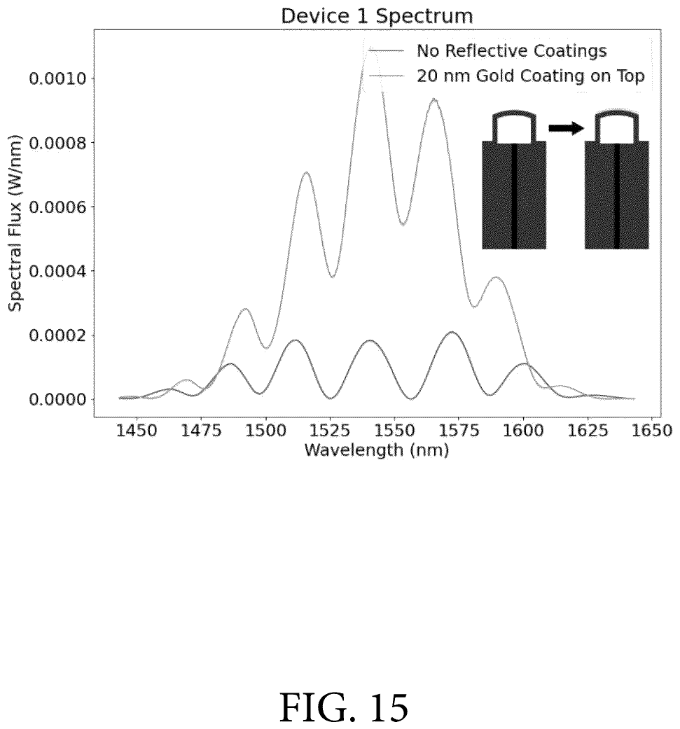

For the open core devices, the top and bottom layers could be controlled roughly independently. Using the same device from the first test, a reflective gold layer was deposited on the top by using sputtering deposition. The gold layer thickness was theoretically 20 nm, meaning the reflectance should be about 95%. The same optical test was done again, to see the impact of a single reflective layer on the top. A full figure for comparison is shown in FIG. 15. The main benefit of adding gold on the top is getting a higher return power. However, the quality factor is still only 1.002, a slight decrease.

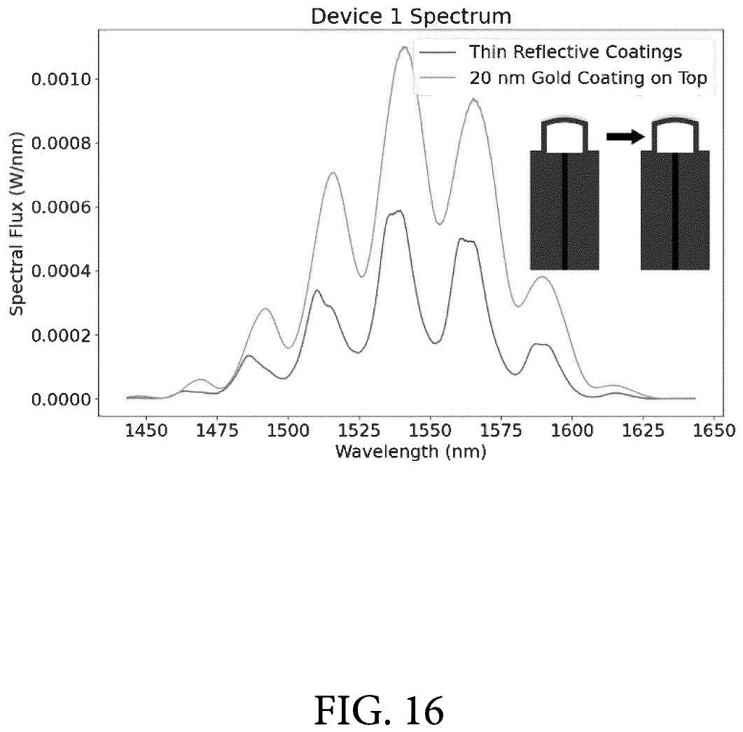

For another test, a thin gold film was deposited on the bottom of the device. The theoretical gold thickness sputtered was 10 nm according to previous characterizations, which would theoretically yield a reflectance of 65% and a transmittance of 30%. FIG. 16 shows a reflected spectra for a same device with two reflective coatings, and a reflective coating only on the top. The only difference with a reflective coating on the bottom is a slightly lower return power. The quality factor is still 1.002.

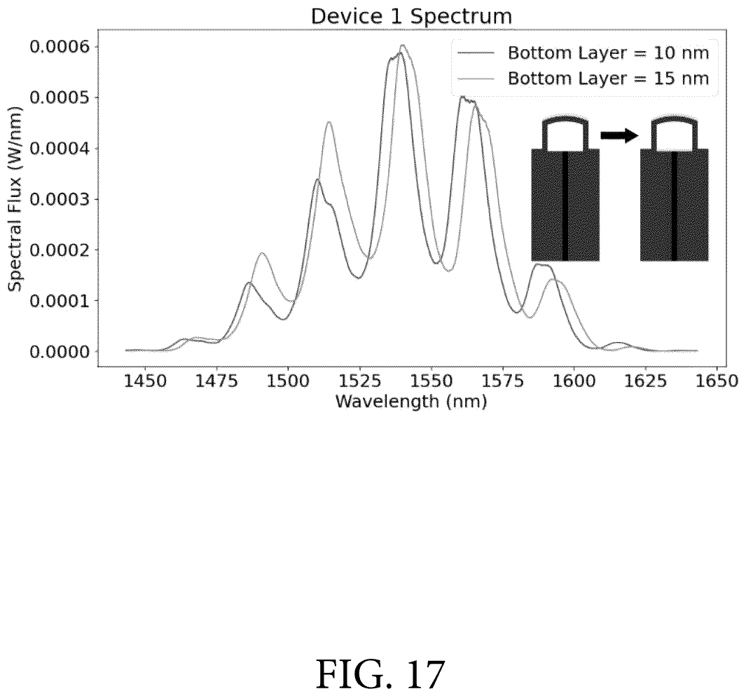

In yet another test, a thin gold coating was deposited on the bottom to increase the reflectance of the bottom mirror. Results of this test are shown in FIG. 17, which shows a reflected spectra for the same device with different thicknesses of gold coatings on the bottom of the FPC. Making the reflective coating (e.g., gold) on the bottom thicker may not improve the quality factor. After this point, so little light may return to cause FPC interference, the resonance dips may not be consistently measurable. To increase sensitivity, a high return signal, strong resonance, and high-quality factor are desired.

A key issue discovered in the open core tests is that the light is not able to make multiple round trips inside the FPC and then recouple back into the fiber core. To make sure all the light stays in the cavity and makes it back to the core, the new design may utilize reflective walls (e.g., gold coated walls) to prevent light from leaving the FPC. This construction can require the shadow-mask lithography technique, but has the added benefit of storing more energy in the cavity, which should theoretically increase the quality factor.

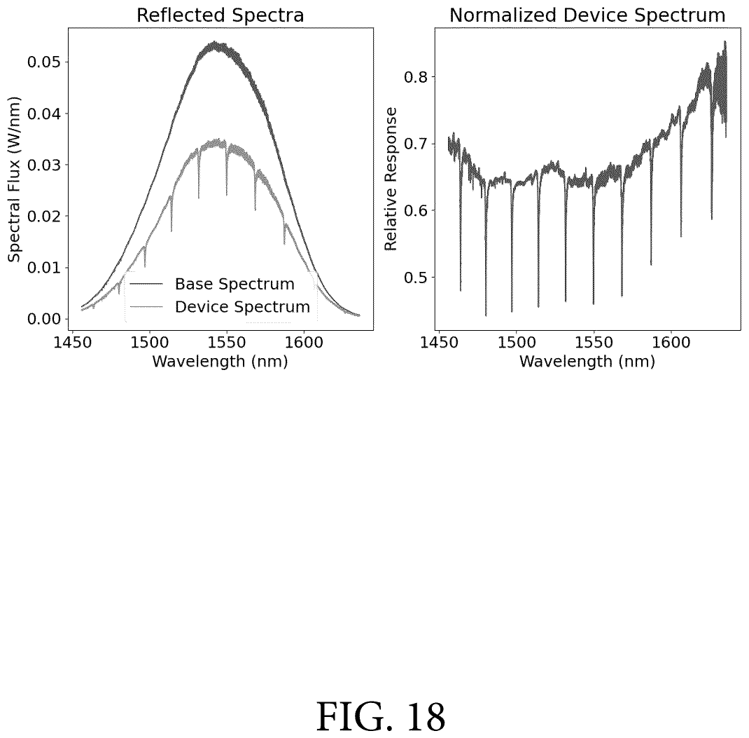

In previous tests, due to the large width of the resonance peaks relative to the sampling of the OSA, the key parameters can be measured directly from the data. However, as shown in FIG. 18, the resonance peaks much narrower, so a different analysis method may be used. The device used to generate these resonance peaks had a core diameter of 15 microns, and theoretically optimized coatings on the top and bottom of the cavity. FIG. 18 (left) shows direct measurements of the base spectrum and the return spectrum of a device. FIG. 18 (right) shows a normalized response for the same device.

For determining the important parameters of the narrow peaks, Lorentzian functions were fitted to each individual peak. The base equation used is shown in Equation 17.

$$L ( v ) = ( \frac{Γ}{π} ) ( \frac{S}{{Γ}^{2} + {( v - {v}_{0} )}^{2}} ) . \qquad ( 17 )$$

Here, Γ is the FWHM, Sis a scale factor to adjust the amplitude, and v₀ is the center frequency, based on λ₀, the center wavelength.

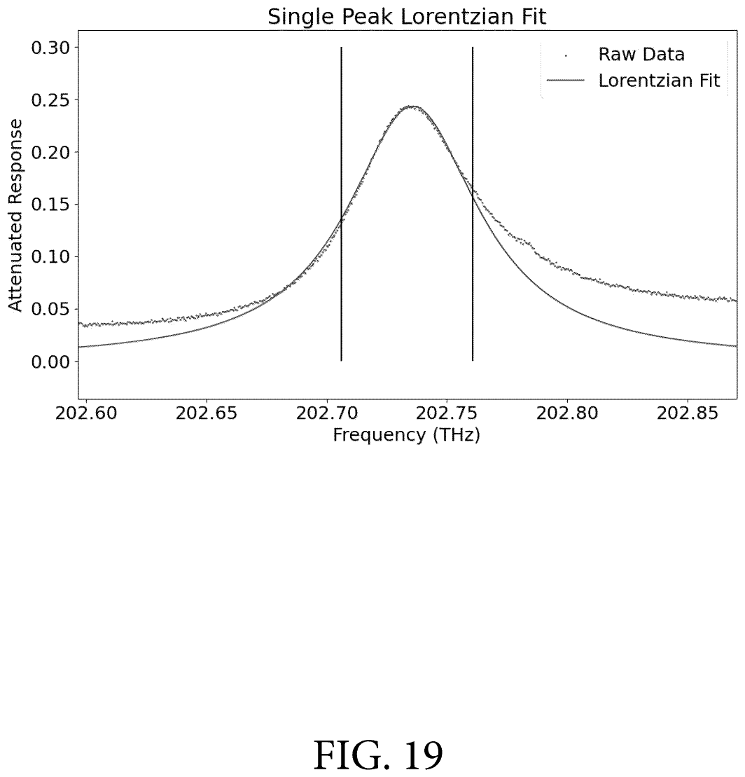

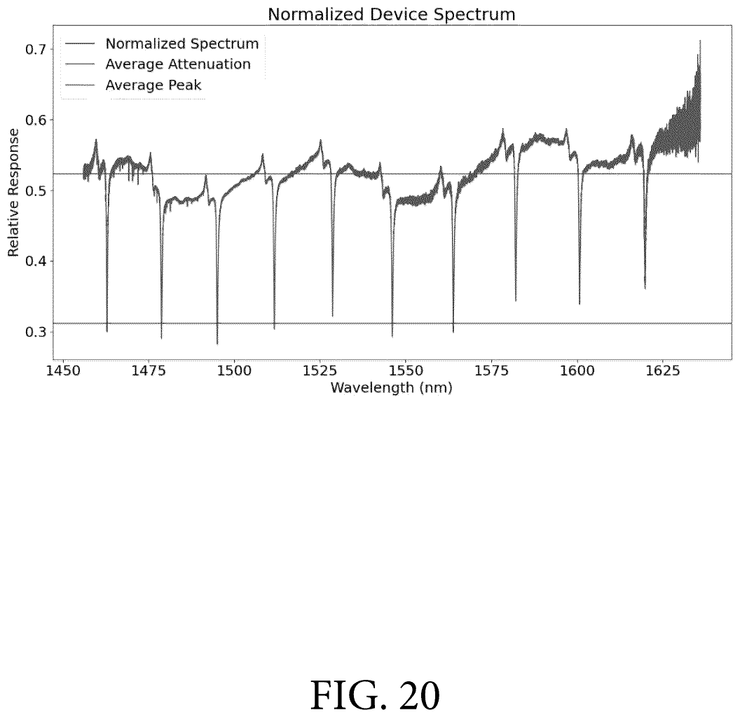

FIG. 19 shows an example of a Lorentzian fit for just one peak. The spectrum is inverted to match the more conventional shape of a Lorentzian function. The data points come from the same spectrum displayed in FIG. 18. Black lines show the range over which data points were considered for the fit. For each resonator, it is important to consider what kind of detector must be paired with the resonator to be able to properly analyze the results. A small FWHM corresponding to a high quality factor means a small shift in the peak moves it to a completely different location, making the change easily distinguishable. High base return power means less light is needed in the system, and the noise floor of the detector can be higher. Strong peak attenuation means the noise requirements of a detector do not need to be very strict. Lowering the requirements of the optical detector will lower the SWAP requirements of the entire system, meaning that the sensor can be more efficiently used. Average attenuation and peak strength are shown in FIG. 20, which, more specifically, shows an average attenuation as a measure of how much power is lost from input to output for this device. This spectrum is normalized to one. Peak strength is a measure of how strong each peak is. This is also measured from 1 for this normalized spectrum.

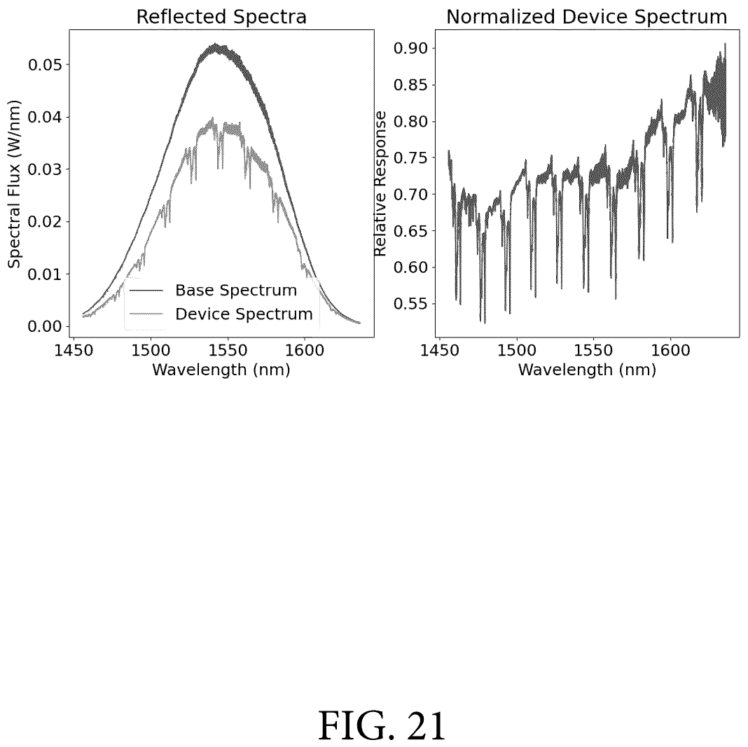

Although the optical confinement in FIG. 18 shows a much higher response and quality factor than the open device in FIG. 13, there can be variance between devices. This can be due to a parasitic resonance in some cavities causing a double peak. An example of this is shown in FIG. 21. The device which produced these resonance peaks had a 20 micron diameter core. Before each main peak, there is a smaller peak that may not show up in all tests of the same design. The double peak was consistent between runs of the same device, but not between devices. When parsing through the data, the stronger peak of every set was considered to be the resonance peak, and the Q calculations were done based on that peak. The weaker peaks are ignored when they appear.

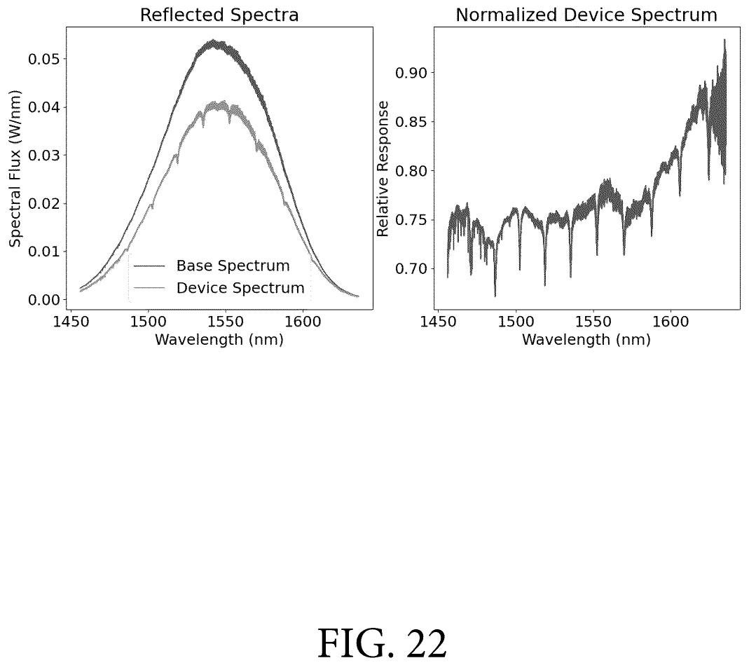

Another difference seen among peaks is slight inconsistencies in attenuation due to resonance. FIG. 18 shows strong resonance, but in FIG. 22, a device with much weaker peaks is shown.

In FIG. 22, although the base return power is very high, not a lot of light was able to make it back into the core to destructively interfere with the return signal. In that regard, this device suffers a similar flaw to the open core devices, but does still have a much higher quality factor. Key results are summarized in Tables 1 through 4. Each of these tables summarizes the results of a different design. For each table, device number is just an index used for testing, but all device numbers on a single table were made with the same fabrication technique.

TABLE 1
Key parameters about the spectra of four different
devices with a 25 micron diameter core.

| Device Number | Average Q | Average Loss (dB) | Average Peak (dB) |
|---|---|---|---|
| 1 | 6756 | \|−2.86 | −4.94 |
| 2 | 5874 | −1.39 | −2.27 |
| 3 | 2400 | −5.38 | −5.57 |
| 4 | 5352 | −0.70 | −1.49 |

TABLE 2
Key parameters about the spectra of three different
devices with a 20 micron diameter core.

| Device Number | Average Q | Average Loss (dB) | Average Peak (dB) |
|---|---|---|---|
| 1 | 6569 | −1.99 | −2.90 |
| 2 | 4117 | −1.96 | −2.89 |
| 3 | 4142 | −4.68 | −5.92 |

TABLE 3
Key parameters about the spectra of four different
devices with a 15 micron diameter core.

| Device Number | Average Q | Average Loss (dB) | Average Peak (dB) |
|---|---|---|---|
| 1 | 6281 | −2.81 | −4.72 |
| 2 | 4806 | −1.93 | −3.04 |
| 3 | 6002 | −1.70 | −2.99 |
| 4 | 5170 | −4.04 | −6.11 |

TABLE 4
Key parameters about the spectra of six different
devices with a 10 micron diameter core.

| Device Number | Average Q | Average Loss (dB) | Average Peak (dB) |
|---|---|---|---|
| 1 | 3092 | −1.09 | −1.81 |
| 2 | 3270 | −3.27 | −3.58 |
| 3 | 2407 | −1.40 | −2.27 |
| 4 | 3031 | −0.89 | −1.82 |
| 5 | 2521 | −1.12 | −1.48 |
| 6 | 3078 | −1.28 | −1.89 |

Tables 1 through 4 show key results of this paper. The shadow mask style lithography on fiber optic tips was to allow high-quality reflective coatings to be deposited on both ends of a fiber tip FPC, as well as monolithically integrating the entire design with the fiber. Of the similar designs covered herein, the highest quality factor reported was 800 by our research group in 2022. However, this high of a quality factor was not very easily repeatable, and only about 10% of devices survived the fabrication process to be tested.

In addition to demonstrating consistently high quality factors, this work also shows high return powers and strong resonances relative to other papers. An ideal FPC would have an average attenuation of 0 dB, and the peak strength would be an infinitely large negative peak. This means it will be very easy for a photodetector to delineate between a resonance peak and slight variations in the normal spectrum. However, this is not a very commonly considered metric for many fiber tip FPC sensors. A few groups report their responses in dB, but their average response is usually around −10 to −20 dB, which is significantly lower than any devices shown here.

With the shadow mask style lithography, not only is the FPC very high quality, it is also very highly repeatable. After the necessary equipment modifications were made to better support this fabrication style, the success rate of devices was roughly 70%, and from Tables 1 through 4, all of the fabricated devices perform far better than other fabrication techniques in terms of Q, average loss, and average peak.

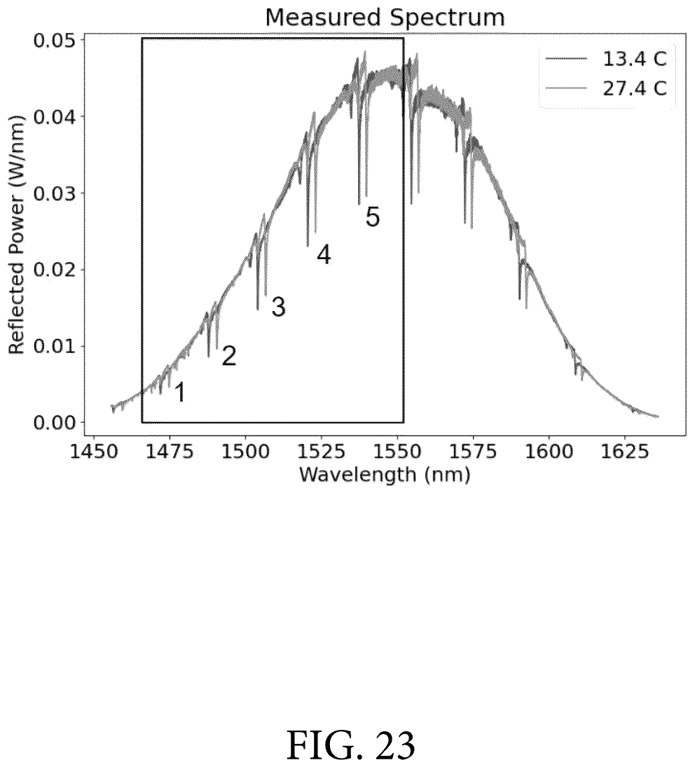

Although the solid core design is very simple, it also acts as a functional sensor. The resin used has not been characterized in terms of its thermo-optic or thermoelastic effect, but both should theoretically be present to some degree. The shift in the resonance peaks will be due to a combination of both effects, but the individual impact of each is not considered herein. Both effects are grouped together into optical path length changes. Due to the high quality factor, only a very small change in optical path length is required to be able to distinguish between two temperatures. To make sure temperature was well-controlled throughout the device, it was submerged in water, which was in turn heated by a hot plate. The temperature of the water was measured with a submersible thermal probe. An example of two spectra from the experiment is shown in FIG. 23.

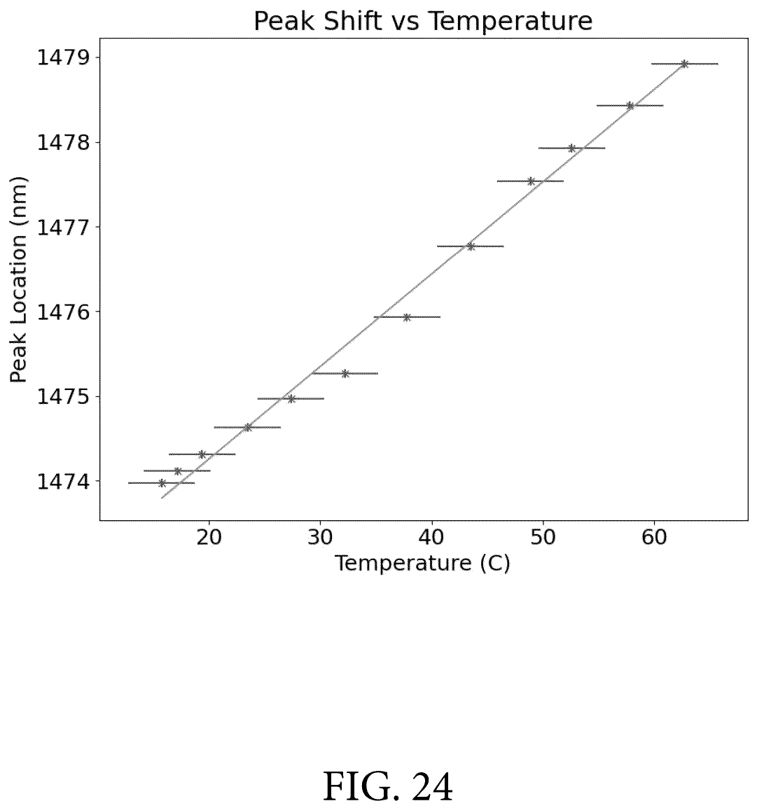

FIG. 23 shows a temperature shift for devices before deformation in water. Also labeled are the peaks considered for testing. These peaks were chosen since they never shifted outside the sensing range. As the temperature increases, the resonance peaks were red shifted, indicating increasing cavity length. Theoretically, by tracking the movement of a single peak, the temperature could be determined after some calibration. However, there is a finite range over which the spectrum is measured. If the peaks move outside that window, they can no longer be tracked. Additionally, new detectable peaks might appear in the window. Both of these issues are solved by only tracking peaks that are detectable the entire time. An example of this is shown in FIG. 24. This figure shows a temperature shift for peak 1 before deformation in water. Error bars are due to uncertainties in the thermal probe. Uncertainties in peak location were negligible. The equation for this line is p(T)=1472 nm+0.108 nm/° C.×T, and R²=0.9916. It is it is notable that the quality of the device remained constant throughout the sweep over temperature. Five different peaks were tracked, and their linear fit parameters are shown in Table 5, which shows key parameters about the temperature sensing of different resonance peaks. The resin has a non-linear response with respect to temperature, as seen by the higher sensitivity at higher wavelengths.

TABLE 5
Key parameters about the temperature
sensing of different resonance peaks

| Peak Number | Slope (nm/C) | Intercept (nm) | R² |
|---|---|---|---|
| 1 | 0.108 | 1472 | 0.9916 |
| 2 | 0.110 | 1488 | 0.9921 |
| 3 | 0.111 | 1504 | 0.9919 |
| 4 | 0.112 | 1520 | 0.9920 |
| 5 | 0.114 | 1537 | 0.9924 |

To be able to distinguish between two different temperatures, the location of peak must move by a detectable amount. Due to the accuracy of the OSA, the fitting program can place the location of each peak to within 0.7 pm in most cases, meaning the temperature sensing capability of peak 5 would be approximately 0.006° C. However, if a much lower quality OSA was used, and the FWHM was the temperature sensing threshold, since the FWHM is around 0.23 nm in most cases, the temperature sensing accuracy would be approximately 2.0° C.

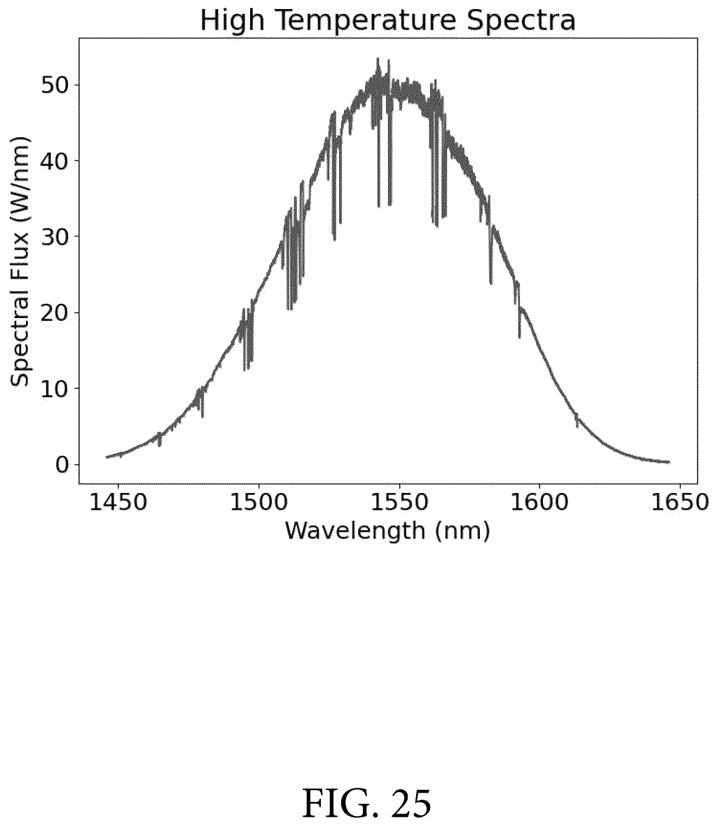

In addition to just testing the temperature in water, an air temperature sensor was also tested. This was done by suspending the device a few millimeters above the hotplate and then turning it on. However, because the device is so small, it was able to heat and cool much faster than the OSA could measure the spectrum. Therefore, a single peak would move and be recorded multiple times, causing a spectrum like in FIG. 25.

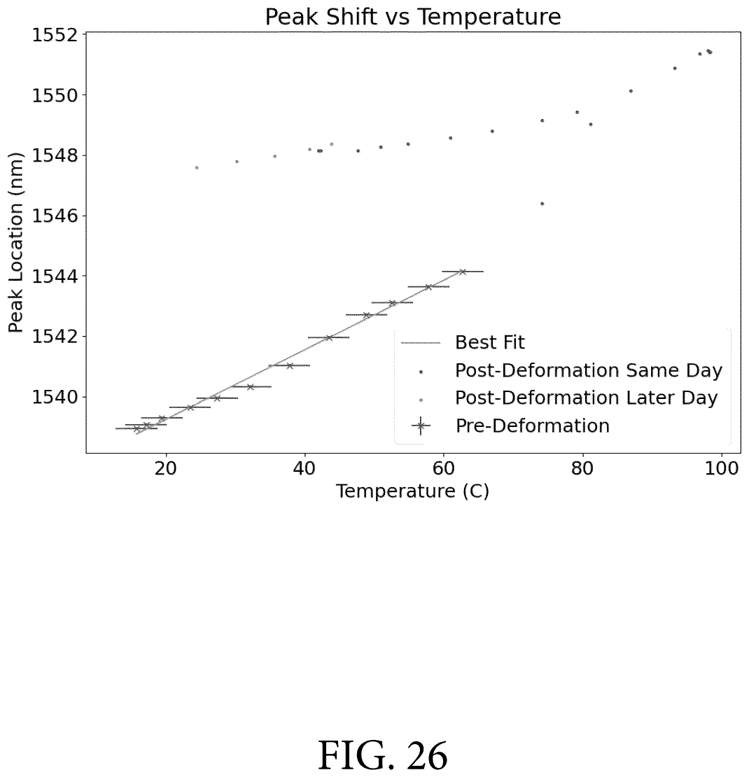

More extensive temperature testing could not be done because of permanent deformation of the devices after reaching around 80° C. Even after letting the devices rest at room temperature for a few days, measurements still showed a decrease in sensitivity, as shown in FIG. 26.

One possible reason for this deformation is paint from the holder coming off and coating the device. The resin theoretically stable up to 386° C., the fibers and gold likewise, but to keep the magnetic holder in the water, a painted piece of iron was secured to the optics table and submerged in the beaker. Unfortunately, there were no more devices available for testing, so other holders could not be tested.

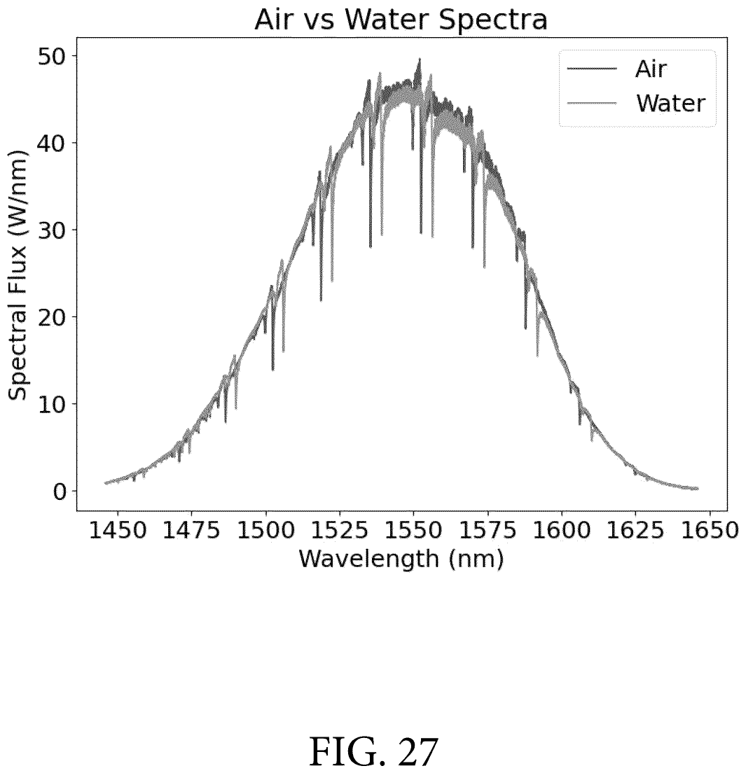

Another problem noticed with the temperature sensor is that the device acts as a refractive index sensor. This was immediately noticeable when the device was put into water, as shown in FIG. 27. To keep bubbles from sticking to the device, the water can be constantly agitated with a stir rod during testing.

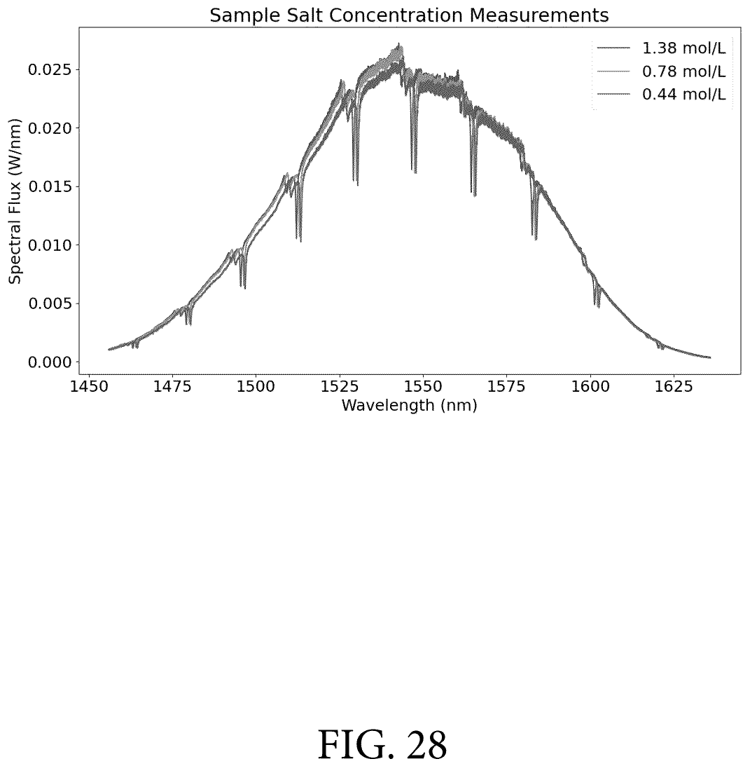

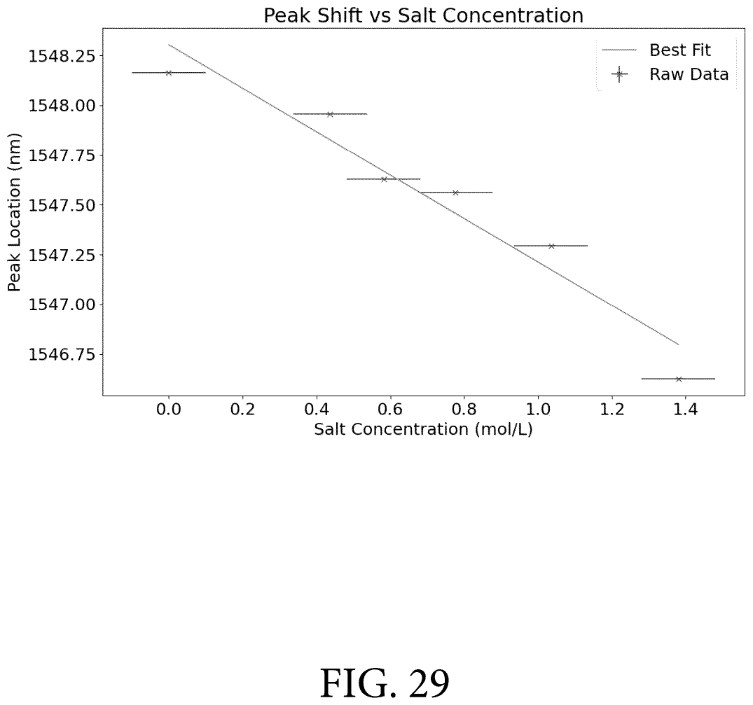

An RI sensing test can be completed using acetic acid, sodium chloride (salt), and deionized (DI) water. Since the exact RI at the wavelengths of interest could not be measured in some instances, all shifts were reported with respect to chemical concentration. An example of peak shifting due to chemical concentration differences in salt is shown in FIG. 28. Exemplary tests may start with a maximum salt concentration, and then some solution may be removed and replaced with DI water to decrease the concentration. This could lead to chemical hysteresis. To minimize possible hysteresis effects, the solution can be left to mix for five minutes for each test. Example of one peak shift being tracked is shown in FIG. 29. Like the temperature tests, five peaks were trackable throughout the tests. The peaks are the exact same as in FIG. 23. The results of each linear fit are shown in Table 6, which gives key parameters about the salt concentration sensing of different resonance peaks. The resin has a non-linear response with respect to concentration, as seen by the higher sensitivity at higher wavelengths.

TABLE 6
Key parameters about the salt concentration
sensing of different resonance peaks

| Peak Number | Slope (nm/(mol/L)) | Intercept (nm) | R² |
|---|---|---|---|
| 1 | −1.068 | 1481 | 0.927 |
| 2 | −1.076 | 1497 | 0.929 |
| 3 | −1.080 | 1514 | 0.931 |
| 4 | −1.083 | 1531 | 0.932 |
| 5 | −1.090 | 1548 | 0.937 |

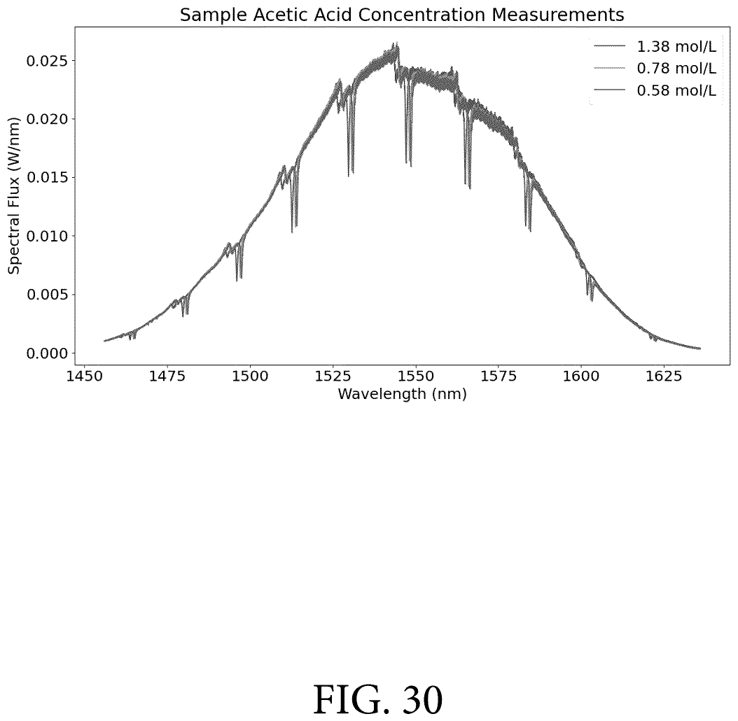

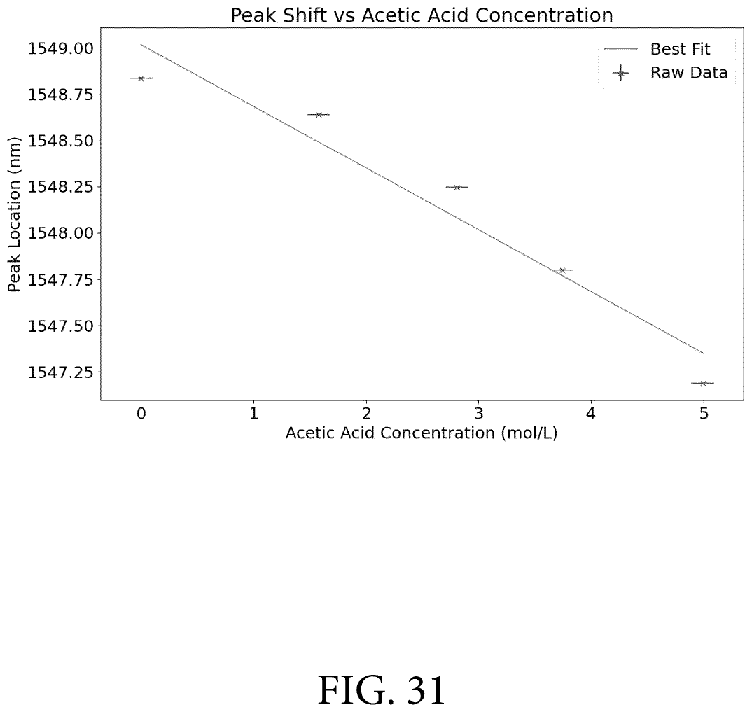

The next test was done with acetic acid of varying concentrations. FIG. 30 shows a visible spectrum shift for a different concentrations of acetic acid in water. Once again, the test started with the maximum concentration and then was slowly diluted with DI water. The same peaks as in FIG. 23 were tracked for this test as well. Due to the smaller effect of acetic acid on the spectrum shifts, only five tests were done. Tracking the same peaks as in the salt testing, a linear model was made for acetic acid concentration. An example peak shift is shown in FIG. 31. Like the temperature tests, five peaks were trackable throughout the tests, so the results of each linear fit are shown in Table 7. As shown in Table 7, the resin has a non-linear response with respect to concentration, as seen by the higher sensitivity at higher wavelengths.

TABLE 7
Key parameters about the acetic acid concentration
sensing of different resonance peaks.

| Peak Number | Slope (nm/(mol/L)) | Intercept (nm) | R² |
|---|---|---|---|
| 1 | −0.329 | 1482 | 0.932 |
| 2 | −0.330 | 1498 | 0.933 |
| 3 | −0.332 | 1515 | 0.934 |
| 4 | −0.331 | 1532 | 0.936 |
| 5 | −0.334 | 1549 | 0.937 |

Due to the accuracy of the OSA, the peak center can be placed to accuracies well less than the FWHM. For both results, this kind of accuracy is necessary, because some of the shifts seen in FIG. 29 and FIG. 31 are less than the smallest FWHM observed. However, because of the capabilities of the test equipment, this sensor can be used as an effective chemical concentration sensor.

It should now be understood that fiber optic FP sensors have the ability to provide a large amount of environmental data while maintaining a small size, low weight, and low power requirements. This paper describes a useful fabrication method and demonstrated to make a simple FPC that can act as a temperature and RI sensor. The fiber tip shadow mask lithography can consistently give quality factors over 1000, which is roughly an order of magnitude greater than previous methods. Additionally, the sensor tested here demonstrated a temperature sensitivity of 0.114 nm/C, a salt concentration sensitivity of −1.090 nm/(mol/L), and an acetic acid concentration sensor with a sensitivity of −0.334 nm/(mol/L).

The preceding examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A process for creating a Fabry-Perot Cavity (FPC) sensor using Two-Photon Polymerization (2PP) comprising:
fabricating a mask directly on a cleaved and flat tip of a fiber optic cable, wherein the mask includes:
a beveled central hole aligned directly over the core of the fiber optic cable; and
side extensions that extend radially beyond a cladding of the fiber optic cable with respect to a central axis of the mask;
sputtering a first reflective coating over the mask and tip of the fiber optic cable such that the first reflective coating adheres to the mask where the mask covers the tip and adheres to the core of the fiber optic cable where the tip is exposed;
mechanically removing the mask using the side extensions such that the first reflective coating adhered to the fiber optic cable remains as a precisely centered gold disc on the tip;
fabricating a resonator cavity structure (RCS) using a 2PP process over the gold disc, wherein the RCS includes a RCS tip;
sputtering a second reflective coating over the RCS tip, wherein the second reflective coating adheres to an external surface of the RCS tip, and
wherein the first reflective coating and the second reflective coating are aligned in parallel such that the resonator cavity structure acts as an FPC when light passes along the fiber optic cable and through the first reflective coating.

2. The process for creating a FPC sensor of claim 1, wherein the first reflective coating is between 10 and 25 nm.

3. The process for creating a FPC sensor of claim 2, wherein the first reflective coating is 20 nm.

4. The process for creating a FPC sensor of claim 1, wherein the second reflective coating is thicker than the first reflective coating such that the second reflective coating is less transmissive than the first reflective coating.

5. The process for creating a FPC sensor of claim 4, wherein the second reflective coating greater than 35 nm.

6. The process for creating a FPC sensor of claim 1, wherein one or more of the first reflective coating and the second reflective coating is selected from one or more of the following coatings: gold, silver, platinum, and aluminum.

7. The process for creating a FPC sensor of claim 4, wherein one or more of the first reflective coating and the second reflective coating is gold.

8. The process for creating a FPC sensor of claim 1, wherein the second reflective coating displays zero transmittance.

9. The process for creating a FPC sensor of claim 1, wherein the radius of the beveled central hole of the mask is based on the radius of the core of the fiber optic cable.

10. A process for creating a Fabry-Perot Cavity (FPC) sensor using Two-Photon Polymerization (2PP) comprising:
fabricating a mask directly on a cleaved and flat tip of a fiber optic cable, wherein the mask includes:
a beveled central hole aligned directly over the core of the fiber optic cable; and
side extensions that extend radially beyond a cladding of the fiber optic cable with respect to a central axis of the mask;
sputtering a first reflective coating over the mask and tip of the fiber optic cable such that the first reflective coating adheres to the mask where the mask covers the tip and adheres to the core of the fiber optic cable where the tip is exposed;
mechanically removing the mask using the side extensions such that the first reflective coating adhered to the fiber optic cable remains as a precisely centered gold disc on the tip;
fabricating a resonator cavity structure (RCS), wherein the RCS includes a RCS tip;
sputtering a second reflective coating over the RCS tip, wherein the second reflective coating adheres to an external surface of the RCS tip, and
wherein the first reflective coating and the second reflective coating are aligned such that the resonator cavity structure acts as an FPC when light passes along the fiber optic cable and through the first reflective coating.

11. The process for creating a FPC sensor of claim 10, wherein the first reflective coating is between 10 and 25 nm.

12. The process for creating a FPC sensor of claim 11, wherein the first reflective coating is 20 nm.

13. The process for creating a FPC sensor of claim 10, wherein the second reflective coating displays a lower transmittance than the first reflective coating.

14. The process for creating a FPC sensor of claim 13, wherein the second reflective coating is greater than 35 nm.

15. The process for creating a FPC sensor of claim 10, wherein one or more of the first reflective coating and the second reflective coating is selected from one or more of the following coatings: gold, silver, platinum, and aluminum.

16. The process for creating a FPC sensor of claim 15, wherein one or more of the first reflective coating and the second reflective coating is gold.

17. A Fabry-Perot Cavity (FPC) sensor comprising:
a first reflective surface comprising a reflective disc deposited through a removable mask, the mask having been fabricated directly on a tip of a fiber optic cable,
a resonator cavity structure (RCS) fabricated using a 2PP process over the reflective disc, wherein the RCS includes an RCS tip;
a second reflective surface deposited on the RCS tip, such that the first reflective surface and the second reflective surface are in optical communication to create an FPC when light passes along the fiber optic cable and through the first reflective coating, wherein, the mask, while on the fiber optic cable, includes:
a beveled central hole aligned directly over the core of the fiber optic cable; and
side extensions that extend radially beyond a cladding of the fiber optic cable with respect to a central axis of the mask.

18. The FPC sensor of claim 17, wherein the second reflective coating displays zero transmittance.

19. The FPC sensor of claim 18, wherein the first reflective coating is between 10 and 25 nm.

20. The FPC sensor of claim 19, wherein the first reflective coating is between 13 and 22 nm.
